(19) United States
(12) Patent Application Publication
(10) Pub. No.: US 2006/0213595 A1
(43) Pub. Date: Sep. 28, 2006

(54) Retractable Spike Pin Snow Tire

(76) Inventors: Kevin Volt, Atlantic City, NJ (US); Sao Van Vo, Atlantic City, NJ (US); Chinh Vo.lt, The Colony, TX (US)

Correspondence Address: KEVIN VOLT, 2717 FAIRMONT AVE., ATLANTIC CITY, NJ, 08401, US

(21) Appl. No.: 10/907,284

(22) Filed: Mar. 28, 2005

(51) Int. Cl. B60C 11/00

(52) U.S. Cl. 152/210

(57) ABSTRACT

The embodiment of this invention is a retractable spike pin snow tire. The retractable spike pin units are radially embedded in the road contact surface of specially designed vehicle tires. The retractable spike pin unit utilizes SMA (Shape Memory Alloy) actuators to provide mechanical forces for the spike pin. When activated electronically as needed by the driver, or by tire traction sensors, the plurality of spike pins will protrude out from the metal housings. These protruded pins will cling onto the ice covered or snow pressed road surface and provide needed extra grips for tires on slippery road conditions. When not in need the pins will be retracted back into their metal housing electronically by the driver's input, or by sensors.

### FIELD OF THE INVENTION

The present invention relates to a snow tire with retractable spike pin units. This snow tire is to use in automobiles/vehicles where ice covered, snow pressed, and other slippery road conditions are major safety concerns.

### BACKGROUND OF THE INVENTION

For years, automobile and vehicles with special equipped tires including chained tires and other forms of fixed, built in spike tires have been used widely during winter season in order to prevent slippery, to increase gripping contact to the road surface therefore minimizing property damages and above all bringing safety to all forms of life, human being in particular. However, there has arisen a serious environmental problem for society in that a large amount of dust is formed due to the use of spike tires, and to the rapid increase in the amount of traffic in towns and cities. This is based on a fact that when vehicles equipped with spike tires run on a paved road which is not covered with snow, the tips of the spike pins cut or scrape the pavement material such as asphalt or concrete to form fine particles thereof or dust which then are scattered and float in the air. In order to avoid dust pollution problem, some of the snow tire designs include the concept of permitting the vehicle driver to control the raising or lowering of these tread studs of tires when a slippery road condition occurs. This generally requires that the system be actuated either electrically, hydraulically, or by compressed air. However, these prior inventions are technically cumbersome, unreliable, and above all very costly (cited from Yisu U.S. Pat. No. 4,676,289 and Omi U.S. Pat. No. 5,164,027)

Therefore the present invention is the best appropriate solution for the above dilemmas provided by our present technologies. The retractable spike pin snow tire can be activated/spike protruding or deactivated/spike retracting whenever needed; whether a vehicle/car is stand still or in motion; therefore, road surface damage and dust problem can be avoided or reduced to tolerably minimum level.

### SUMMARY OF THE INVENTION

The present invention provides a needed road traction performance for automobile or other forms of vehicles equipped therewith is run on a snow covered or icebound road without unnecessary scraping on the road surface. One of the beauties of the present invention is that when the retractable spike pin units are not activated the tire is no difference compare to a normal tire in term of appearance and performance. Therefore, the present invention snow tire can be used all year round, in all weather conditions, and above all, it is ready to provide extra road traction when needed in a split second. Importantly, the spike pin units can be removed from the tire and safely stored away during seasons in which there is no snow or ice; in order to prevent unnecessary wear and tear. They are easily produced and maintained. Another very important advantage of the present invention is that each spike pin unit or each component of a unit can be interchangeable, removed, and reused when the tire is worn out. Therefore, the cost of using snow tire is very affordable for everyone.

In summary, the object of the present invention can be achieved through the combination of forms and functions of the following components:

Accordingly, in one aspect, the present invention provides Model # 1 and Model # 2 retractable spike pin units for the snow tire:

(1) Model # 1 “Single SMA Actuator” Retractable Spike Pin Unit model comprised of (SMA, hereafter, referred as Shape Memory Alloy):
(a) a top metal cap with a built in electrical terminals
(b) a light weight, hollow cylindrical steel case with special internal longitudinal groove patterns.
(c) a light weight, high tensile stress and strain steel or metal alloy spike with specially designed shape.
(d) a plunger
(e) a SMA spring.
(f) a rubber O ring
(g) a light weight steel bottom cap
(h) a counteract spring.

(2) Model # 2 “Double SMA actuator” Retractable Spike Pin Unit comprised of:
(a) a top metal cap with a built in electrical terminals
(b) a light weight, hollow cylindrical steel case with special internal structure.
(c) a light weight, high tensile stress and strain steel spike with specially designed shape.
(d) a SMA spring.
(e) a SMA ring actuator
(f) a rubber O ring
(g) a light weight steel bottom cap

(3) In another aspect, the present invention provides a snow tire comprising:
(a) a rubber base tire having a road engaging surface formed with a plurality of cylindrical holes extending radially and arranged uniformly space apart on the protruded treads.
(b) At the upper end of each hole is a light weight steel or metal alloy flange tightly embedded in the rubber matrix of road engaging surface.
(c) a Compact Electrical Control Unit (CECU) comprised of a light weight DC rechargeable battery, a sensor unit, and a remote control receiver unit.
(d) rows of small electrical wire system either embedded or glued onto the inner peripheral surface of the road engaging surface.

(4) a remote control unit mounted on the dash board of an automobile or wherever that is conveniently controlled by a driver.

### BRIEF DESCRIPTION OF THE DRAWINGS

FIG. 1 a transverse section of a snow tire with retractable spike pin units located at protruded treads.

FIG. 2 a longitudinal section of a snow tire with retractable spike pin units according to the present invention.

FIG. 3 an exploded view of the longitudinal section of a snow tire with a retractable pin unit screwed tightly to a flange.

FIG. 4 a bottom view of the plunger of Model # 1 retractable pin unit.

FIG. 5 a top view of the spike pin of Model # 1 retractable pin unit.

FIG. 6 a perspective view of the plunger of Model # 1 retractable pin unit.

FIG. 7 a perspective view of the pike pin of Model # 1 retractable pin unit.

FIG. 8 a longitudinal section of Model # 1 retractable pin unit with perspective view of internal components.

FIG. 9 a top view of the top cap of Model # 1 retractable pin unit.

FIG. 10 a bottom view of the bottom cap of Model # 2 retractable pin unit.

FIG. 11 an exploded view through AA′ and BB′ sections of the internal circumferential surface of the housing case with longitudinal groove and bar pattern of Model # 1 retractable pin unit.

FIG. 12 a top view of the spike pin of Model # 2 retractable pin unit.

FIG. 13 a perspective view of the spike pin of Model # 2.

FIG. 14 a top view of Model # 2 retractable pin unit.

FIG. 15 a longitudinal section of the Model # 2 retractable pin unit with perspective view of internal components.

FIG. 16 a bottom view of the Model # 2 retractable pin unit.

FIG. 17 a perspective view of the SMA ring actuator.

### DETAILED DESCRIPTION OF THE PRESENT INVENTION

Hereinafter, each of the retractable spike pin unit will be described in further detail with reference to preferred embodiments illustrated in the attached drawings.

1—Model # 1: Single SMA Actuator Spike Pin Unit model
(a) a strong, light weight steel/alloy hollow cylindrical structure, as shown in FIG. 8, with specially designed longitudinal grooves and raised bars on the inner circumferential surface FIG. 11. Actually the grooves are the spaces between longitudinal raised bars 32. There are two sets of grooves with different groove sizes. Each smaller groove 31 is alternately positioned between two larger grooves 30 and vice versa. A smaller set of grooves is for the studs of the plunger 10 and the larger set of grooves is for the studs of the spike pin 13 since the size of the spike pin's studs are bigger than their counter parts. Also the lower end of each smaller groove is blocked by a connecting bar 33. The connecting bar is raised feature connecting from the lower end of one raised bar to body of the other raised bar at an angle. This oblique connection creates a recess 34. The cylinder serves as the housing for the spike pin and other components of the spike pin unit. The inner circumferential screw threads at the top 18 and bottom 28 portion of the cylinder are the screwing points of the top cap 17 and the bottom cap 27 respectively. The upper end external screw threads 19 are screwed tightly to the metal flange 7 FIG. 3 which is embedded in the rubber matrix 4 FIG. 3 of road contact surface of tire. Also the housing case acts as one of the two electrical conducting pathways for the SMA spring to one of the top cap's electric terminals 15.
(b) a strong, light weight steel/alloy top cap, as shown in FIGS. 8 and 9, with screw threads, and built in electrical terminals 15 and 16. The top cap is screwed onto the internal upper screw threads 18 of the housing case.
(c) a Shape Memory Alloy SMA spring 21 FIG. 8. The spring serves as an actuator to provide forces to push the spike pin, as shown in FIG. 7, outwardly. The upper end of the spring 22 is securely fastened against the top cap via a hole of the top cap 15A FIGS. 8 and 9. The lower end of the spring pushes against the plunger as shown in FIG. 8. An electrical wire connects the upper end of the SMA spring 22 to the electrical terminal of the top cap 16 in FIGS. 8 and 9. The lower end of the SMA spring 23 is electrically connected to the other electrical terminal 15 of the top cap by using the metal housing as its electrical conductor since the lower end of the SMA spring, the plunger, and the metal housing are always in contact or friction to each other
(d) The plunger, as shown in FIGS. 4 and 6, is located between the SMA spring and the spike pin. It has a circular gear tooth feature 11 at its bottom end surface and four radial studs 10. During activation/deactivation the studs slide up and down respectively inside the smaller longitudinal groove set 31 of the housing case. A connecting bar 33 at the lower end of each smaller groove prevents these studs from sliding out of the grooves. Its circular gear teeth 11 interact with the circular gear teeth of the spike pin 12 FIG. 5 during activation
(e) A strong light weight metal alloy spike pin, as shown in FIGS. 5 and 7 with special shape including four radial studs 13 and the circular gear tooth feature 12 at the top surface. Unlike the plunger studs' range of motion, the spike pin's studs can slide out of their grooves 30. During activation, the radial studs slide down and out of the groove in order to “lock” onto the recesses 34 FIG. 11 which are wedge-shape recesses formed between connecting bars 33 and longitudinal bars 32. During deactivation, the studs slide back in and down the groove. The circular gear tooth feature 12 is located at the top end surface of the spike pin as shown in FIG. 5. The circular gear teeth 12 interact with similar circular gear teeth of the plunger 11 whenever the plunger is pushing down
(f) a rubber O-ring 26 in FIG. 8 prevents dust, moisture, and debris from getting inside the housing case by snuggly apposition to the circumferential surface of the spike as the spike moving up and down
(g) a steel alloy bottom cap 27 FIGS. 8 and 10. It is crewed into the lower end of the housing case 28. It has a circular opening 29 where the spike pin tip 14 protruding through during activation
(h) a counteract spring 24 in FIG. 8 is a small normal steel spring. It provides a counter balance force to push the spike pin upward and stabilize it

2—The components from (a) to (h) put together will form a completed Model # 1 Retractable spike pin unit. Each retractable spike pin unit is inserted into, screwed, and tightly held by the flange of tire. A whole unit or each individual component of the unit can be replaced separately when needed.

The SMA helical spring actuator 21 is provides force to push the spike pin FIG. 7 out to its protruded position when the unit is activated. The SMA spring changes its shape from the resting state (non-stretching) to stretching state when the temperature of the spring is increased to its predetermined critical temperature. The critical temperature of the SMA spring is determined by the proportions of each metal in that alloy, Nickel and Titanium in the Nitinol in particular. In this case, the heat is provided by the spring's own electrical resistance when a DC current runs through it. The degree of stretching of the SMA spring is temperature dependence. When no electric current runs through it the spring cools down and gradually shrinks back to its resting state. The main problem with using the SMA/Nitinol spring as an actuator is the switching time from resting to stretching and then back to the resting state. The activating-deactivating cycle is determined mostly by the time taken to cool the spring back to the ambient temperature/the resting temperature. The approach taken to go around this problem is to increase the surface area of the SMA spring actuator, therefore increase heat dissipation rate, by using the helical shaped spring. Fortunately, most of the time when snow tires needed is winter; so the freezing temperature environment provides extra cooling advantage.

Model # 1 Mechanism of operation: when ice is present on road surface, the spike pin unit is being activated and an electric current runs through the SMA spring 21. The spring begins to heat up, stretches out, and pushes the plunger FIG. 6 downwardly. The plunger, in turn, then pushes against the spike pin. As the pin being pushing down, the pin's studs 12 is sliding down the grooves 30 until they slide out of the grooves. As the studs sliding out of the grooves, they simultaneously rotate slightly clockwise and press against the raised recesses 34. At this very moment the thermo-diode sensor tells the switch to cut off the electric current to the SMA spring. The SMA spring begins to cool down, stops stretching, then shrinks or contracts. As the SMA spring contracting, the spike pin is pushing up by the counteract spring 24. It pushes the pin up and “locks” the studs tightly against the raised recesses 34. At this position, the raised recesses prevent the pin from retracting back in as the pin tip is pushing against ice covered road as shown in FIG. 3. Now the tip of spike pin 14 is protruded out of the bottom cap opening 29 and bites into the icebound or snow covered road surface as shown in FIG. 3. This action provides the tires with extra grips onto the slippery road surface.

When no ice or pressed snow present on the road surface, the driver or traction control sensor provides an input signal to turn the unit OFF/retracting the spike's tip into its housing. Now the electrical switch lets electric current runs through the SMA spring 21 again. The SMA spring heats up and begins to stretch out rapidly, pushing the spike pin's studs 13 out of the raised recesses 34 and over the tip of the raised bar 32. Again, just as the studs passing over the tip of the bars, they simultaneously rotate slightly clockwise and the pin's studs move to next groove 30 structure. At this very moment, the thermo-diode sensor tells the switch to cut off the electrical current to the SMA spring 21. The spring begins to cool and contracts. As the SMA spring contracting, the counteract spring 24 pushes the spike pin upward; therefore, the studs further up along the grooves 30. Now the tip of the pin 14 is retracted back into the housing. The whole ON and OFF cycle takes about several seconds.

The plunger's function is to help the spike spin rotate in clockwise direction every time it is being pushed down by the expanding spring as described in the above paragraph. This rotational action is brought about by a slightly offset position between plunger's gear teeth 11 and spike pin's gear teeth 12 during their interaction. This rotational action is to ensure that each of the spike pin's studs 13 rotationally slides away from its previous position and onto its new position, which is either to the raised recesses 34 or to its grooves 30, every time the plunger pushing down on the spike pin corresponded to ON and OFF signal respectively.

During summer months when the retractable spike pin system is not in use, they can be unscrewed and safely stored away to prevent unnecessary wear and tear. A rubber button then can be put in place to prevent unnecessary dirt and debris from getting inside the holes.

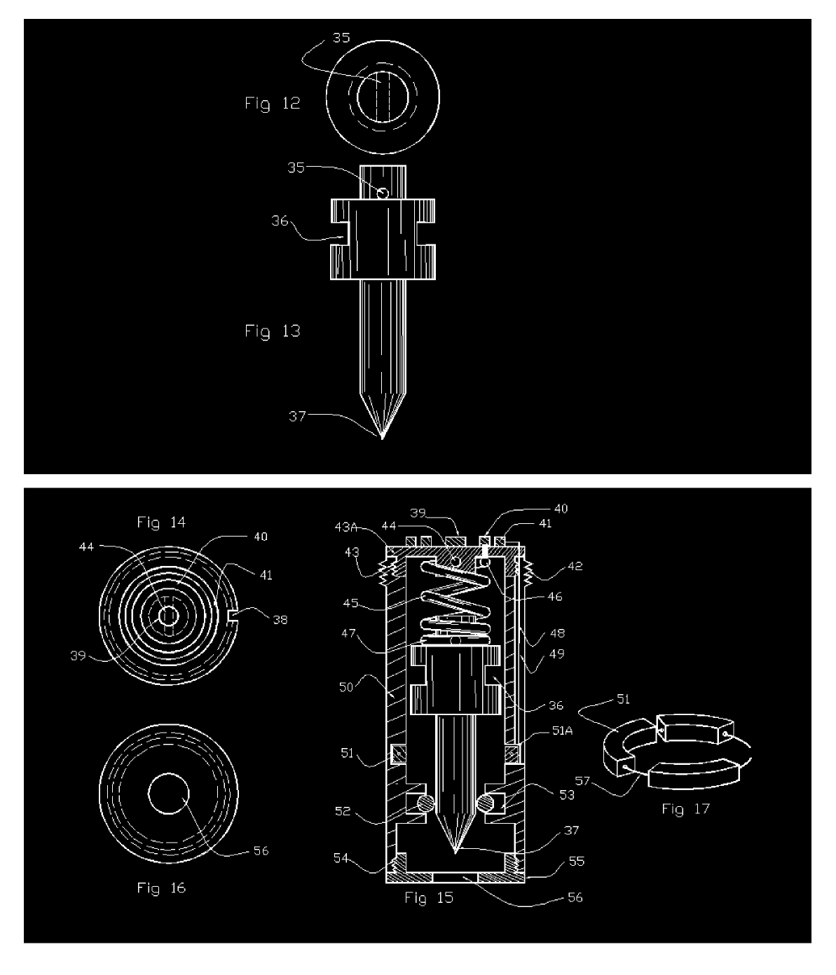

3—Model # 2 Double SMA Actuator Spike Pin Unit model
(i) a steel/alloy hollow cylindrical case as shown in FIG. 15 with a circular rectangular-shaped groove structure 51A on the inner peripheral surface of the cylinder. The groove 51A serves as a platform where the ring actuator FIG. 17 is located and partially slides in and out during activation/deactivation. The cylinder serves as the housing for the spike pin, as shown in FIG. 13, and other components of the spike pin unit as shown in FIG. 15. The inner circumferential screw threads at the top 43 and bottom 54 portion of the cylinder are the screwing points of the top cap 43A and the bottom cap 55 respectively. The upper end external screw threads 43 are screwed tightly to the metal flange 7 FIG. 3 which is embedded in the rubber matrix 4 FIG. 3 of road contact surface of tire. Also the housing case acts as one of the two electrical conducting pathways for the SMA actuators to the top cap's electric terminal 39 FIG. 15
(j) a strong, light weight steel/alloy top cap 43A FIG. 15 with built in electrical terminals 39, 40, 41 in FIGS. 14 and 15. The top cap is screwed to the top of the housing case
(k) a spring actuator 45 FIG. 15 is a helical shaped spring made of shape memory alloy. The spring serves as an actuator to provide forces to push and retract the spike pin FIG. 13. The upper end of the spring 46 is securely fastened against the top cap via a hole of the top cap 44 FIGS. 14 and 15. The lower end of the spring 47 pushes against the top of spike pin. Also this lower end of spring is securely fastened to the spike pin through a small hole 35 on the spike as shown in FIGS. 12 and 13. An electric wire connects the upper end 46 of the SMA spring to one of electrical terminals of the top cap 40. The lower end 47 of the SMA spring is electrically connected to the other electric terminal 39 of the top cap by using the metal housing as its electrical conductor since the lower end of the SMA spring, the spike pin, and the metal housing are always in contact or friction to each other. The SMA helical spring's mechanism of action is exactly the same as the SMA spring of the Model # 1. Please refer to the SMA helical spring of Model # 1 description for details!
(l) a strong light weight metal/alloy spike pin FIG. 13 with a circumferential rectangular-shaped groove 36. This groove is where the ring actuator's arched keys 51 FIGS. 15 and 17 are latched into during activation.
(m) a ring actuator, as shown in FIG. 17, comprised of an opened-ends, shape memory alloy ring 57 with three arched steel keys 51 attached. It is snuggly housed, but still able to move smoothly, inside the circumferential groove 51A FIG. 15 of the metal housing. There is a thin electrical insulation layer between the SMA ring 57 and those steel arched keys 51. One end of the SMA ring connects to one of the top cap's electric terminal 41 via an electrical wire 48 running inside a narrow, external longitudinal groove of the housing case 49. The other end of the SMA ring uses the metal housing case as an electric conductor to one of the top cap's electrical terminal 39. This ring actuator is only activated (electrical current runs through it) when the spike pin unit is being turned OFF (pin tip is being retracted). When an electric current runs through it. It heats up and expands radially. When not activated, the ring actuator is contracted pre-tensionally so that the arched keys' radius is slightly smaller than the radius of the spike pin's cross section. This allows the arched keys 51 snuggly wrap around the spike pin and readily to lock into the groove 36 of the spike pin as soon as the groove slides passing over them.
(n) a rubber O-ring 52 FIG. 15 prevents dust, moisture, and debris from getting inside the housing case by snuggly apposition to the circumferential surface of the spike pin.
(o) a light weight steel alloy bottom cap 55 FIG. 15. It is crewed into the lower end screw threads 54 of the housing case. It has a circular opening 56 FIGS. 15 and 16 where the spike pin tip 37 protruding through during activation.

4. The components from (h) to (o) put together will form a completed Model # 2 Retractable spike pin unit. Each retractable spike pin unit is inserted into, screwed in, and tightly held by the flange 7 of tire. A whole unit or each individual component of the unit can be replaced separately when needed.

Model # 2 Mechanism of operation: when ice is present on road, the spike pin unit is turned ON. An electric current runs through the SMA spring 45. It heats up, expands, and pushes the spike pin down until its circumferential groove 36 is passing over and being locked in by the ring actuator's arched keys 51. At this very moment the thermo-diode sensor unit sends a signal to cut off the electric current running through the SMA spring 45. Now the spike pin is locked by the arched keys which prevent the pin from retracting back in as the pin tip is pushing against ice covered road. Now the tip of spike pin is 37 being protruded out of the bottom cap opening 56 and bites into the ice covered or compressed snow road surface as shown in FIG. 3. This action provides the tire with extra grips onto the slippery road surface.

When no ice presents on the road surface, the driver or traction control sensor provides an input signal to turn the spike pin unit OFF/pin retracting. Now the switch lets an electric current runs through the ring actuator 57. The ring actuator heats up, expands out radially, and pulls the arched keys 51 out of the pin's groove 36. As soon as the arched keys are pulling away the pin's groove, the spike pin is immediately pulled up by the passive tension of the cooling SMA spring 45. Now the spike tip is retracted back in. The whole cycle of ON and OFF takes about several seconds.

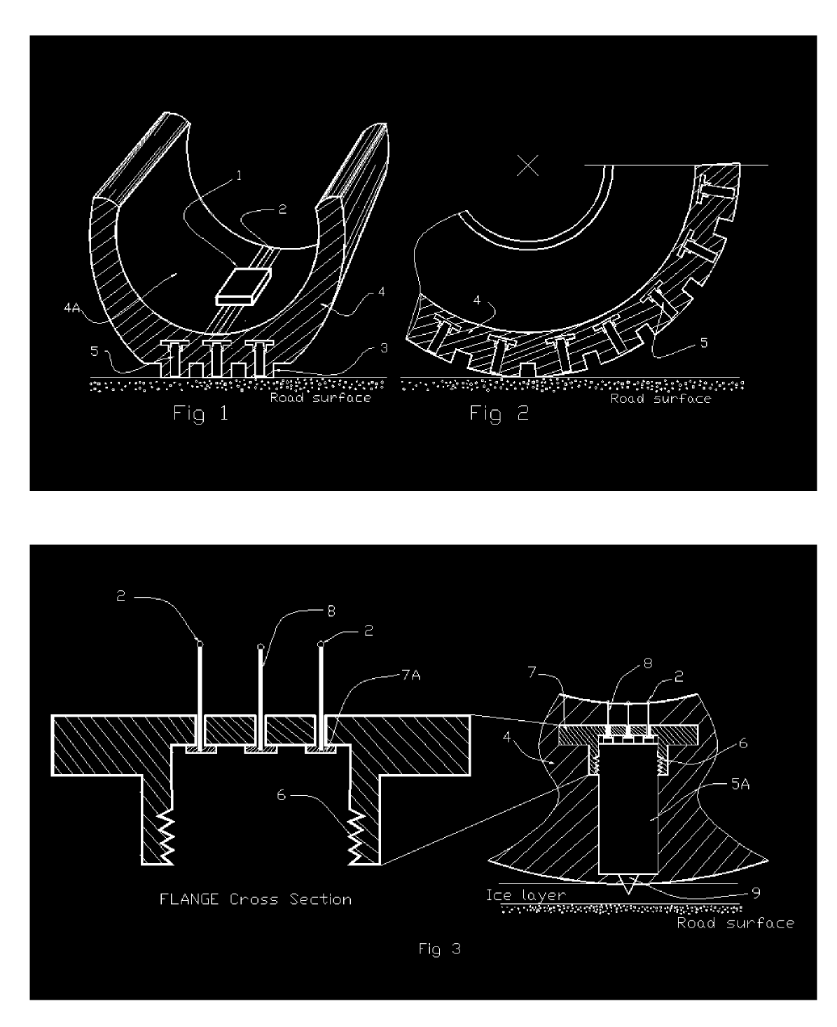

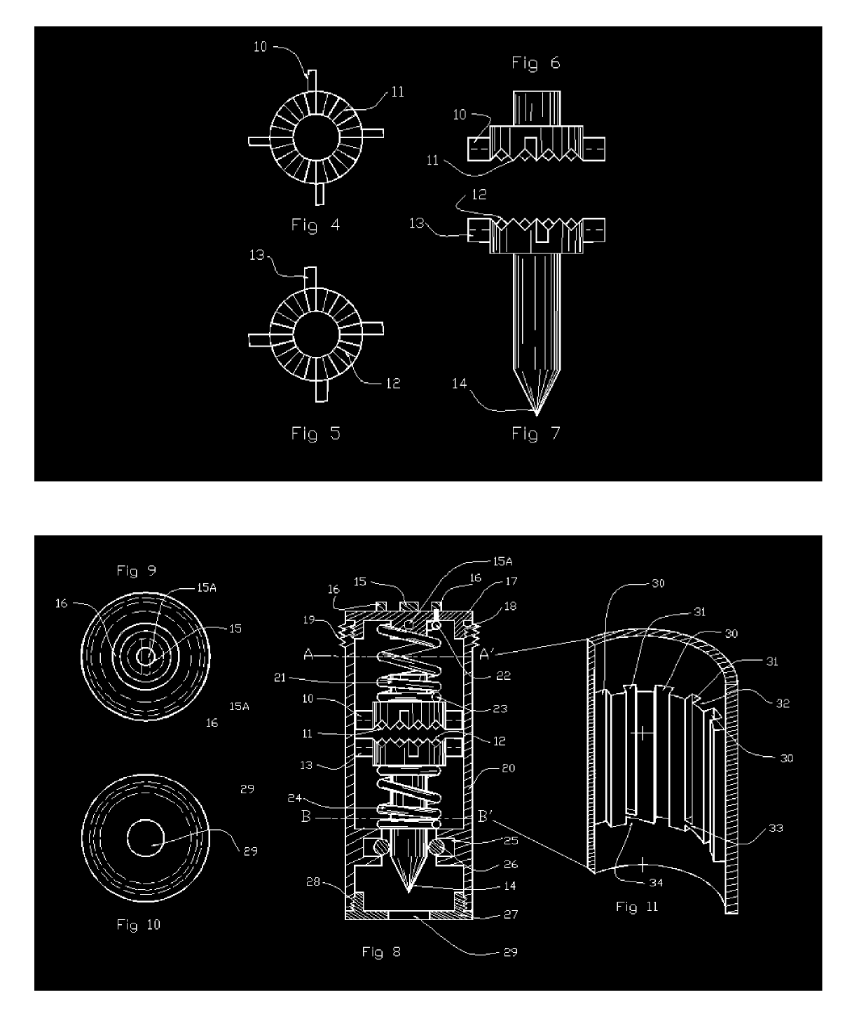

5—Snow Tire and Its Electrical Components:
(a) a rubber base tire with built in plurality of hollow cylindrical holes 5 in FIGS. 1 and 2 extended radially and uniformly spaced apart on the protruded tread portions 3 of the road engaging surface of tire. At the top of each hole is a light weight steel alloy flange 7 FIG. 3 tightly embedded in the rubber matrix 4 of road engaging surface. The flanges provide the anchor points for the retractable spike pin units 5A through their inner circumferential screw threads 6. The flange has either 2 or 3 electrical terminals 7A FIG. 3 (depends on which model of the spike pin in use). These electrical terminals 7A relay electrical current from battery source to top cap's electrical terminals. Each hollow structure securely houses one retractable spike pin unit 5A. There is no air communication between tire's cavity 4A and hollow cylindrical holes 5.
(b) Rows of small electrical wires 2 FIG. 1 either embedded onto or glued onto the inner circumferential surface of road engaging surface. These electrical wires interconnect between electronic switching system and the DC power source to each of the electrical terminals of the flanges.
(c) A Compact Electrical Control Unit (CECU) 1 FIG. 1 comprised of a compact power source, a sensor unit, and a remote control receiver built together as one block. The small compact DC power source is a small size 3 to 9 volts rechargeable Cad Li battery. The electrical connections between the battery and spike pin units (relaying via the tire's flanges' electrical terminals) are in parallel circuit fashion to ensure that each of spike pin unit receives the same amount of voltage from the power source. For the battery recharging purpose, there could be a small, built in, plug-in electrical outlet either located on the rim of wheel or on the tire itself. The thermo diode sensor is a simple electronic circuit that detects the temperature of those shape memory alloy spring or ring actuators by measuring their electrical resistances. The thermo-diode sensor acts as an electrical regulator to regulate (ON or OFF) the electrical current from the battery to spike pin units. The sensor cuts off electric current to the SMA actuators when predetermined electrical resistances are reached in order to ensure proper activation/deactivation and to save electrical energy. The remote control receiver acts as a communication center to relay information between retractable spike pin units, thermo-diode sensor, and driver's control unit.

6. A remote control unit is either mounted on the dash board of an automobile or wherever that is conveniently controlled by a driver.

7. The specific dimensions of the above claimed components of tire and spike pin units are determined by the size of tires and other manufacturing modifications.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be resorted to, falling within the scope of the invention.

What is claimed is:

1. A retractable spike pin snow tire is comprised of a rubber base tire with plurality of cylindrical holes located at the protruded tread portions of road engaging surface; each hole tightly houses one retractable spike pin unit via a flange embedded in the rubber matrix at the upper end of each hole; on the inner peripheral surface of tire located a Compact Electrical Control Unit (CECU) which is comprised of a small rechargeable battery, a sensor unit, and a remote control receiver unit; there is row of electrical wires interconnect between the CECU and electrical terminals of flange of each cylindrical hole; there are two models of said retractable spike pin units; a remote control unit is either mounted on the dash board of an automobile or wherever that is conveniently controlled by the driver.

2. Model # 1 Single SMA (Shape Memory Alloy) Actuator Retractable spike pin unit comprised of
said a top metal cap with a built in electrical terminals;
said a light weight, hollow cylindrical steel case with special internal longitudinal groove patterns;
said a light weight steel or metal alloy spike;
said a plunger;
said a SMA (Shape Memory Alloy) spring actuator with two ends electrically connected to top cap's electrical terminals; this SMA spring actuator provides mechanical force acting on the spike pin;
said a rubber O ring;
said a light weight steel bottom cap with a central circular opening where the spike pin protruding through during activation;
said a counteract spring.

3. Model # 2 Double SMA Actuator Retractable Spike Pin Unit comprised of
said a top metal cap with a built in electrical terminals;
said a light weight, hollow cylindrical steel case with special internal structure;
said a light weight, high tensile stress and strain steel spike with specially designed shape;
said a SMA (Shape Memory Alloy) spring actuator with two ends electrically connected to top cap's electrical terminals; this SMA spring actuator provides mechanical force acting on the spike pin;
said a SMA (Shape Memory Alloy) opened-ends ring actuator with two ends electrically connected to top cap's electrical terminals;
said a rubber O ring;
said a light weight steel bottom cap with central opening where the spike pin protruding through during activation.
